(19) United States
(12) Patent Application Publication
(10) Pub. No.: US 2010/0153968 A1
(43) Pub. Date: Jun. 17, 2010

(54) EXTERNAL RENDERING OF CLIPBOARD DATA

(76) Inventor: CHRISTOF ENGEL, Rauenberg (DE)

Correspondence Address: FISH & RICHARDSON, P.C., PO BOX 1022, MINNEAPOLIS, MN, 55440-1022, US

(21) Appl. No.: 12/332,954

(22) Filed: Dec. 11, 2008

(51) Int. Cl. G06F 9/46

(52) U.S. Cl. 719/313

(57) ABSTRACT

Systems, software, and computer implemented methods are described for rendering data into a clipboard and for automatically converting that data from an initial format to a target format. A computer program product is encoded on a tangible machine-readable medium, where the product comprises instructions for causing one or more processors to perform operations. These operations can include receiving a request to copy information from a first application to a clipboard, with the clipboard configured to provide subsequent transfer of the data to target applications. The information is automatically converted into a target format associated with a second application disparate from the first application. The computer program product can further execute operations such as storing the converted information in the target format in memory for use by the clipboard.

### TECHNICAL FIELD

The present disclosure relates to software and methods involving data management and, more particularly, to system, software, and methods for converting and embedding data objects in a format external to the original data format.

### BACKGROUND

Computer operating systems generally have capabilities that allow for data within an application to be moved or copied from one location to another within the application. These capabilities are commonly known as clipboard or drag-and-drop functions. The clipboard and drag-and-drop functions are designed to provide an easy method for users to transfer data either between different locations within the same application or from one application to another directly compatible application, which are often tightly integrated or bundled. For example, the drag-and-drop function may be used to select data within an application with a user-interface device such as a mouse and copying the data to another application by “dragging” the mouse pointer on the computer screen from the first application to the second application. The appearance of “dragging” the data across the computer screen provides the user with a visual handle on the process of copying the data from the first application into the second application.

When data is copied using the clipboard function, the data is stored in memory allocated for temporary storage, often simply referred to as the “clipboard,” before it is transferred to its target location. Data is temporarily stored in the clipboard, for, when a user enters the copy or cut command in the application. This data is stored the format that is was being manipulated by that application. When the user enters a paste command for the same data, the data is retrieved from the clipboard and copied to the target location. Similarly, the drag-and-drop function of an operating system can employ a “hidden” memory for clipboard-like functionality for transferring data between locations. The accessibility of the data in the clipboard, however, is normally limited by the fact that it is the initial application that renders the data into the clipboard, and only subsequent applications (if any) that are compatible with the format of the data rendered by the initial application may retrieve the data from the clipboard.

### SUMMARY

The present disclosure provides techniques for extending an application's clipboard functionality by supporting the rendering of data in formats unknown to the application in order to copy the data to the clipboard. In one configuration, a computer program product is encoded on a tangible machine-readable medium, where the product comprises instructions for causing one or more processors to perform operations. These operations can include receiving a request to copy information from a first application to a clipboard, with the clipboard configured to provide subsequent transfer of the data to target applications. The information is automatically converted into a target format associated with a second application disparate from the first application. The computer program product can further launch, implement, store, or otherwise execute operations such as storing the converted information in the target format in memory for use by the clipboard.

Various implementations can include the following features. For example, the techniques can include the use of an application programming interface (API) or script to control external applications in order to render data in the appropriate format for the clipboard. In this particular example, the API or script can comprise any program, module, or text that exposes the clipboard functionality of that external application to others. The client application requests the user to specify which target format or external application to use to render the data. If the user does not specify which external application to use, the client application determines the appropriate external application based on the original format of the data to be rendered. The external application that is utilized provides an API or is called by a script that permits control of the external application for creating and saving data objects. Once the data has been rendered within the external application, the client application maintains control over the external application and allows the user to further process and manipulate the data in its target format.

While generally described as computer implemented software that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a diagram depicting a system with the major elements of the present disclosure;

FIG. 2 is a block diagram depicting the components of one embodiment of the system of FIG. 1; and

FIG. 3 is a flow chart describing an example process of the present disclosure using an appropriate system, such as the system described in FIG. 1.

### DETAILED DESCRIPTION

This disclosure generally describes techniques for allowing a first application to copy data to the clipboard, or any other similar memory for “drag and drop” functionality, in formats compatible with a second disparate application. For example, the present disclosure describes systems, software, and computer implemented methods that help facilitate data being copied from the first application to the clipboard in a disparate format incompatible with the first application so that a second application compatible with the disparate format may access the data from the clipboard. Given that there are software applications that are not compatible with the data formats of other applications, the client could be able to use a second application to process data from a first example spreadsheet application in a format compatible with the second spreadsheet application because the second application can now recognize the data from the first application. In other words, data may generally be stored in the clipboard in any appropriate format regardless of the initial application generating, managing, or otherwise associated with the information. For example, a user of an application may start a drag-and-drop operation or request data to be copied into the clipboard. The application will then render the data in a format that the application is compatible with into the clipboard. An example may be a graphics application, which at the request to copy a bitmap to the clipboard, may render the bitmap data in one of several formats that the application may be compatible with such as JPG, BMP, etc. Likewise, a word processor may render its text in the clipboard as an HTML, WORD, or TXT file. In the context of clipboard and drag-and-drop functionality, the client (or its user) can copy data from the first spreadsheet application into the clipboard as identical data in a format compatible with the second application. In short, the present disclosure can be implemented by calling and controlling the second application through the first application to generate, or render, a data object in a format compatible with the second application and storing the data object in the clipboard. It will be understood that “clipboard” is used to refer to some form of memory that can be used for clipboard, drag-and-drop, or other similar functionality. As such, this data object can be stored in the system's clipboard in the target format for subsequent use by the second application or any other application compatible (directly or via object linking) with the target format.

One potential benefit of this disclosure is that an application can extend its supported clipboard or drag-and-drop formats to support unknown formats, where the unknown formats are rendered by other applications via their APIs, scripts, or other processes and functionality. Further, using the example techniques of the present disclosure, a data object may be collected in one format and embedded as another format without requiring the user to manually open a second application to create a new data object or manipulate the existing object for embedding. For example, a client or other computer using this technology may offer its users and applications easy integration of data formats technologies of other companies and to process data in the format that is preferred or required.

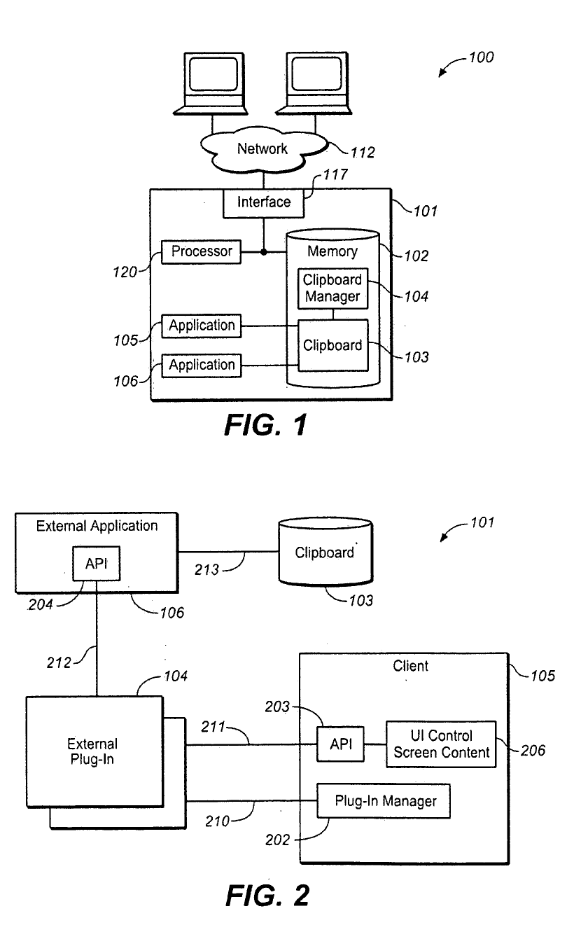

Turning to the illustrated example, FIG. 1 illustrates an example system 100 for converting and copying data to a clipboard 102. The system 100 may include any computer or processing device 101 such as, for example, a server, general-purpose personal computer (PC), Macintosh, workstation, Unix-based computer, touch screen terminal, network computer, kiosk, wireless data port, smart phone, personal data assistant (PDA), one or more processors within these or other devices, or any other suitable processing device. In other words, the present disclosure contemplates computers other than general purpose computers, as well as computers without conventional operating systems. Computer 101 may be adapted to execute any operating system including Windows, Linux, UNIX, Windows Server, or any other suitable operating system. According to one embodiment, computer 101 may also include or be communicably coupled with a web server and/or a mail server.

Illustrated computer 101 includes example processor 120. Although FIG. 1 illustrates a single processor 120 in computer 101, two or more processors may be used according to particular needs, desires, or particular embodiments of system 100. Each processor 120 may be a central processing unit (CPU), a blade, an application specific integrated circuit (ASIC), or a field-programmable gate array (FPGA). The processor 120 may execute instructions and manipulate data to perform the operations of system 100, often using software. Regardless of the particular implementation, “software” may include computer-readable instructions, firmware, wired or programmed hardware, or any combination thereof on tangible medium as appropriate. Indeed, each software component may be fully or partially written or described in any appropriate computer language including C, C++, Java, Visual Basic, assembler, Perl, any suitable version of 4GL, as well as others. It will be understood that while the software illustrated in FIG. 1 is shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The computer also typically includes a user interface, such as a graphical user interface (GUI). The GUI comprises a graphical user interface operable to, for example, allow the user of the client to interface with at least a portion of the platform for any suitable purpose, such as creating, preparing, requesting, or analyzing data, as well as utilizing “cut-and-paste” functionality. Generally, the GUI provides the particular user with an efficient and user-friendly presentation of business data provided by or communicated within the system. The GUI may comprise a plurality of customizable frames or views having interactive fields, pull-down lists, and buttons operated by the user. The GUI is often configurable, supports a combination of tables and graphs (bar, line, pie, status dials, etc.), and is able to build real-time portals, where tabs are delineated by key characteristics (e.g. site or micro-site). Therefore, the GUI contemplates any suitable graphical user interface, such as a combination of a generic web browser, intelligent engine, and command line interface (CLI) that processes information in the platform and efficiently presents the results to the user visually. The server can accept data from the client via the web browser (e.g., Microsoft Internet Explorer or Mozilla Firefox) and return the appropriate HTML or XML responses to the underlying engine using a network.

The example client may be communicably coupled with a network 112 that facilitates wireless or wireline communication between the computer 101 and any other local or remote computer, such as clients. The network may be all or a portion of an enterprise or secured network. In another example, the network may be a virtual private network (VPN) merely between the server and the client across wireline or wireless link. Such an example wireless link may be via 802.11a, 802.11b, 802.11g, 802.11n, 802.20, WiMax, and many others. The network may include one or more local area networks (LANs), radio access networks (RANs), metropolitan area networks (MANs), wide area networks (WANs), all or a portion of the global computer network known as the Internet, and/or any other communication platform or systems at one or more locations. The network, however, is not a required component of the present disclosure.

Computer 101 may also include interface 117 for communicating with other computer systems over network 112 in a client-server or other distributed environment. In certain embodiments, computer 101 receives requests for data access from local or remote senders through interface 117 for storage in memory 102 and/or processing by processor 120. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals.

In general, the computer 101 is a computer with memory 102 for storing data and program instructions. The memory 102 of the system may include a block 103 or other cache allocated for temporary storage and use by the clipboard functions of the operating system of the computer 101. The memory block 103 allocated for temporary storage may be referred to as “the clipboard.” A software module, called the clipboard manager 104 for ease of reference without limiting the description, within memory 102 is associated with the clipboard. The clipboard manager 104 interfaces with the applications 105 and 106 of the computer, manages and allocates the memory allocated for the clipboard 103, and services the requests of applications seeking to use the clipboard 103 for temporary storage of data or other information. In other words, it is frequently utilized by the copy, cut, and paste commands provided by applications running on an operating system. For example, the user of application 105 may select a data object within the application 105 and enter a copy command to copy the data object from the application 105 to a separate application 106. Upon receiving the copy command, the application 105 accesses the clipboard 103 through the clipboard manager 104 and generates a copy of the data object to be copied to and stored within the clipboard 103. In another implementation, system 100 stores a list of formats in the clipboard (opposed to the complete data to save memory and CPU), and then when the data is pasted or dropped, it is generated in the appropriate format that the target application requests or is appropriate for.

After the data object is stored within the clipboard 103, the user of an application such as the second application 106 may retrieve the data object from the clipboard 103 by entering a paste command in the second application 106. Thus, both applications 105 and 106 may utilize the clipboard 103 to facilitate the transfer of data from one location to another.

Applications 105 and 106 may be programs stored in the system 101 in memory 102 and have access to the clipboard 103 to copy data to or retrieve data from the clipboard 103. In general, the application in which the data is initially created or currently managed is the application that renders, or generates, the data in its specific format for storage in the clipboard. Once the initial application has rendered and copied the data into the clipboard, a second disparate application may retrieve from the clipboard the data in the same format rendered by the initial application or a format associated with itself or another application. The applications 105 and 106 may have specific capabilities such as business applications, word processing, managing presentations, managing spreadsheets, designing and editing graphics or other multimedia formats, email, managing web pages, personal information management (PIM), etc. The applications may have one specific capability or a plurality of different capabilities. For example, the first application may be a business application that executes or provides a number of application services, including customer relationship management (CRM) systems, human resources management (HRM) systems, financial management (FM) systems, project management (PM) systems, knowledge management (KM) systems, and electronic file and mail systems. The business application may be operable to exchange data with a plurality of enterprise-based systems and, in the process, update or modify one or more content repositories. The various services performed may allow the business application to orchestrate one or more business processes in synchronization with other processes that directly or indirectly affect the information stored within one or more of the content repositories. For instance, the business application may drive business processes across different applications, systems, technologies, and organizations, thus driving end-to-end business processes across heterogeneous systems or sub-systems. A second application 106 may process data of a particular format in accordance with the second application's capabilities. This first application 105, such as an enterprise business application, may utilize similar data in a different format and may be generally incompatible with data in the format utilized by the second application 106. For example, an application that is capable of word processing may process data in WORD or TXT format, but be directly incompatible with multimedia information or individually incapable of providing multimedia information to the clipboard. In another example, the first application may comprise a first version of the particular software application that is not compatible with the target format, while the second application is a second version of the particular software application that is compatible (and is normally capable of the conversion, perhaps via a convertor) with the target format. Regardless, using techniques described herein, the first application 105 may still be capable of storing data in the clipboard 103 in the format associated with the second application 106 for subsequent use by that second application 106 or any other application compatible the target format associated with the second application 106.

In one general implementation, a client application receives a request to render data into the clipboard in a particular target format that is not recognized by the client application. The client application can access the API of an external application that is compatible with the target format in order to control the external application. The client application initializes the external application, creates a new data object within the external application in the target format, generates data into the new data object using the external application, and copies the data object into memory allocated for the clipboard. Although the client application may not be able to render the data in the target format because the format is unknown to the client application, it may render the data through an external application via the external application's API. In another examples, the operating environment or client application may fake a drag from the client application without showing it to the user, such that the user starts dragging in the client app 105 but the system starts dragging in 106. In another example, system 100 may use a temporary storage (such as file, clipboard, memory) to exchange the data from the external app. Once ready, it sends the data back to the client 105, then becomes associated with the running drag operation.

The external applications that are used to render data into the clipboard provide APIs for other applications to use the external application to process data. The external applications are also compatible with the clipboard and drag-and-drop functions of the operating system. In some situations, these applications determine the existence of the plug-in (or clipboard) manager and registers those applications with the manager. Put differently, the registered applications are applications that the client application (or the operating system) may use to render data for copying to the clipboard.

FIG. 2 is a block diagram depicting the conceptual structure of one configuration of the example system. The client application 105 is an application containing the data that a user (or process or application) wishes to copy to the clipboard 103. It will be understood that while this disclosure generally describes the “cut-and-paste” functionality in terms of a user's requests or actions, the processing can occur in response to a service, process, application, or other requester. The client application 105 receives a request from the user to copy data to the clipboard 103. Once the request has been received, the client application 105 initializes a plug-in manager 202 to access the clipboard or drag-and-drop plug-in 104. The plug-in manager 202 is a module that manages and interfaces with external plug-ins such as the clipboard plug-ins, interfaces, scripts, APIs, or other exposed functionality (generally described as “plug-ins” or “APIs”). In general, plug-ins are auxiliary computer programs or processes that interact with host applications to provide additional functionality or expose existing functionality to requesting applications. For example, the clipboard and drag-and-drop plug-ins are computer programs generally provided by operating systems that enable data objects to be temporarily stored and copied in an intuitive and user-friendly manner from one location to another. These plug-ins are accessible to applications that run on the operating system, and clipboard-compatible applications are programmed to take advantage of the specific functions and features of the clipboard and drag-and-drop plug-ins. Some applications, however, may not be compatible with the clipboard or drag-and-drop functions, and the client application may be programmed to register clipboard-compatible applications with the plug-in manager.

If the user has requested that the data be processed by the clipboard 103 (through commands such as copied, cut, pasted, etc.) and rendered in a target format that is not compatible with the client application 105, the client application 105 may request that an external application 106 that is compatible with the target format be used to render the data. The external application 106 is a second application disparate from the client application that will render the data in the client application 105 in the target format requested by the user. Specifically, the client application 105 may utilize a plug-in manager 202 to call a second application 106 and render the data using the second application 106. This may be accomplished by accessing the second application's application programming interface (API) 204. In this context, an API is a set of functions provided by the second application that allows other applications to access and make requests of the second application. For example, Microsoft Office applications provide Office APIs that allow other applications to access Office files through the Office APIs. It is common practice for a data object of one Office application to be embedded in another Office application, wherein the second Office application may allow the user to edit the data object within the second Office application by accessing the API of the first Office application. As understood by those of ordinary skill in the art, however, the applications that provide APIs of similar utility are not limited to Office applications, and many other applications can provide APIs to service requests made by external applications. In the present disclosure, the second application is preferred to have an API that allows for the creation of a document, the addition of data to the document, selecting the data, and copying the data to the clipboard.

Returning to the interaction between the client application 105 and the second application 106, in particular embodiments, the client application 105 may request 210 to the clipboard or drag-and-drop plug-in 104 to render data using a specific second application 106. The clipboard or drag-and-drop plug-in 104 may first retrieve 211 from the client application 105 the data to be rendered into the clipboard 103. In certain situations, this process can be accomplished via the client application's API 203 in much the same way that the second application 106 is accessed to render data to the clipboard 103 using the second application's API 204. In other situations, this process can be accomplished by sending the client data directly via the plug-in manager. The clipboard or drag-and-drop plug-in 104 may use the client application's API 203 to extract 211 from the client application 105 the data to be rendered in the clipboard 103, including screen content 206 of the client application 105. The plugin may then access 212 the API of the second application 204, which then activates the clipboard or drag-and-drop plug-ins 104. The API could then initialize the second application 106 to render the data in the second application's format. In other words, the API could expose the second application's generally functionality and the plug-in could represent or contain the logic to render data with the external Application's API in a certain format. For example, in FIG. 2, the client application 105 calls a second application 106 such as Microsoft's Excel, Word, or PowerPoint via the second application's API 204. The second application 106 may then be controlled by the client application 105 through the second application's API 204 to put the data into the clipboard, perhaps utilizing a dynamic link libraries (DLL) or other plug-in. In one embodiment, the second application 106 is instructed to create a new data object in the target format, recreate the data items from the client application 105 in the new data object, and copy 213 the new data object to the clipboard 103 for temporary storage and retrieval by other applications.

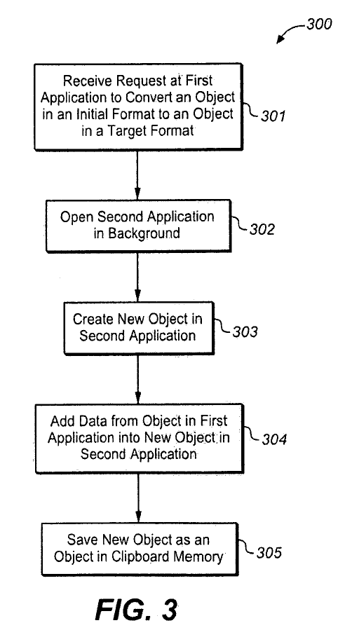

FIG. 3 is a flow chart illustrating one example of the computer implemented method 300 in accordance with embodiment of the present disclosure. In this example, the client application 105 is a first application, which receives a request from the user (or other entity) to copy a data object currently of an initial format as a data object in a disparate target format at step 301. In general, the original format of the data may be a spreadsheet, personal information management (PIM) information, email, graphics, text, HTML, video, or a proprietary format that is each associated with its own application. For example, the business application may utilize a proprietary language to display webpages and their content. The request to copy the object may specify a specific target format or a target application. If not, the first application may ask the user, via some GUI, which target format or application is desired. In some situations, the application or the clipboard manager may automatically determine a default format to use based on the original format of the data in the initial application. For example, if the initial application is a business application that is utilizing data objects with numeric data, then the clipboard manager may automatically select a spreadsheet application as the target application. In other situations, there may be a default file listing, registry entry, file association, or other parameter that identifies the particular target application, which may be overridden by the user via the GUI. In short, if the initial format of the data object is converted to the target format using an external application before or as the data is copied to the clipboard.

Once the second application is identified, the second application is called at step 302, often via the second application's API. This API can help service other applications in the creation, processing, and saving of data items, thereby the first application may control the second application for rendering data into the clipboard. Using this example API, the second application can be initialized and controlled in the background while the first application is running. In this example, the second application is instructed by the first application (or the manager) to create a new data object with the same format as the target format at step 303. The second application then populates the new data object within the second application with data based on the original data object created by the first application at step 304. In some situations, this population may involve manipulation of individual data entries, such as converting a language or between character sets (e.g. UTF-8 (8-bit UCS/Unicode Transformation Format) or ASCII), or manipulation of the data set as a whole, such as adding watermarks, confidentiality stamps, copyright notices, icons, and so forth. For example, there might be some transformation of numerical data such as adding some statistical columns. After the data is added to the new data object, the second application stores the new data object into the clipboard for retrieval by other applications at step 305.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously and/or in different orders than as shown. Moreover, environment 100 may use processes with additional steps, fewer steps, and/or different steps, so long as the methods remain appropriate. For example, while example method 300 discusses creation of a new data object in the target format, such creation may instead involve massing the existing data structure in runtime to format it in the target format.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer implemented method for causing a processor to convert an object from an initial format to a target format, the method comprising:
receiving a request to copy information from a first application to a clipboard, the clipboard configured to provide subsequent transfer of the data to target applications;
automatically converting the information into the target format associated with a second application disparate from the first application; and
storing the converted information in the target format in memory for use by the clipboard.

2. The method of claim 1, wherein the second application includes a scripting option that allows requesters to control certain functionality within the second application.

3. The method of claim 1, wherein the target format is a format not supported by the first application.

4. The method of claim 1, wherein conversion of the format of the object comprises the first application compatible with the object's initial format using scripts to control the second application for converting the object into the target format.

5. The method of claim 1, wherein converting the information into the target format associated with a second application comprises:
initializing the second application;
creating a new object within the second application; and
populating the new object with the original information.

6. The method of claim 1, wherein the conversion of the format of the object further comprises editing or manipulating the object in its target format.

7. The method of claim 1, further comprising registering applications that are clipboard compatible with the plug-in manager.

8. The method of claim 1, wherein the second application provides an application programming interface that allows the clipboard manager to retrieve the data in the target format from the first application.

9. The method of claim 1, wherein the first application requests the user to input the target format or second application for conversion.

10. The method of claim 1, wherein the first application determines the appropriate target format or second application to use for conversion.

11. The method of claim 1, wherein the initial format of the information comprises one of a spreadsheet, Personal Information Management (PIM) information, a graphic, text, HyperText Markup Language (HTML), video, or a proprietary format, and each format is associated with a particular application.

12. A computer program product encoded on a tangible machine-readable medium, the product comprising instructions for causing one or more processors to perform operations comprising:
receiving a request to copy information from a first application to a clipboard, the clipboard configured to provide subsequent transfer of the data to target applications;
automatically converting the information into a target format associated with a second application disparate from the first application; and
storing the converted information in the target format in memory for use by the clipboard.

13. The computer program product of claim 12, wherein the information may be a data object, wherein the data object is an item of data that may be individually selected or manipulated.

14. The computer program product of claim 12, wherein the second application includes a scripting option that allows requesters to control certain functionality within the second application.

15. The computer program product of claim 12, wherein the target format is a format not supported by the first application.

16. The computer program product of claim 12, wherein the second application includes a scripting option that allows requesters to control certain functionality within the second application.

17. The computer program product of claim 12, wherein converting the information into the target format associated with a second application comprises:
initializing the second application;
creating a new object within the second application; and
populating the new object with the original information.

18. The computer program product of claim 12, wherein the conversion of the format of the object further comprises automatically manipulating the information to reach its target format.

19. The computer program product of claim 12 further operable to register the second application as providing the target format.

20. The computer program product of claim 12, wherein the second application provides an application programming interface that allows the clipboard manager to retrieve the data in the target format from the first application.

21. The computer program product of claim 12 further operable to provide a graphical user interface to process a user request to input the target format for conversion.

22. The computer program product of claim 12 further operable to determine the target format based, at least in part, on an automatic determination from the first application.

23. The computer program product of claim 12, wherein the target format of the information comprises one of a spreadsheet, Personal Information Management (PIM) information, a graphic, text, email, HyperText Markup Language (HTML), video, or a proprietary format, and each format is associated with a particular application.
